(19) United States
(12) Patent Application Publication
(10) Pub. No.: US 2026/0056412 A1
(43) Pub. Date: Feb. 26, 2026

(54) AUGMENTED REALITY DEVICE COMPRISING WAVEGUIDE ASSEMBLY WITH LIGHT SOURCE ATTACHED

(71) Applicant: SAMSUNG ELECTRONICS CO., LTD., Suwon-si (KR)

(72) Inventors: Youngwoo JANG, Suwon-si (KR); Heonjun HA, Suwon-si (KR); Chulkwi KIM, Suwon-si (KR)

(21) Appl. No.: 19/237,013

(22) Filed: Jun. 13, 2025

Related U.S. Application Data
(63) Continuation of application No. PCT/KR2025/007022, filed on May 23, 2025.

(30) Foreign Application Priority Data
Aug. 23, 2024 (KR) 10-2024-0113592
Oct. 30, 2024 (KR) 10-2024-0150942

(51) Int. Cl. G02B 27/01; G02B 27/00

(52) U.S. Cl. CPC G02B 27/0172; G02B 27/0081; G02B 27/0093; G02B 2027/0138; G02B 2027/014; G02B 2027/0174; G02B 2027/0178

(57) ABSTRACT

An augmented reality device includes a transparent member in which a waveguide is defined. The transparent member includes a first region through which light is inputted thereto and a second region through which at least a portion of the light is outputted therefrom. The augmented reality device includes a coating layer attached to the transparent member and around the first region of the transparent member in a plan view. The augmented reality device includes a light source, configured to output light onto the first region of the transparent member, and attached to the coating layer. The coating layer is configured to reflect at least a portion of light propagated within the transparent member.

### CROSS-REFERENCE TO RELATED APPLICATIONS

This application is a continuation of International Application No. PCT/KR2025/007022 designating the United States, filed on May 23, 2025, in the Korean Intellectual Property Receiving Office and claiming priority to Korean Patent Application Nos. 10-2024-0113592, filed on Aug. 23, 2024, and 10-2024-0150942, filed on Oct. 30, 2024, in the Korean Intellectual Property Office, the disclosures of each of which are incorporated by reference herein in their entireties.

### BACKGROUND

### Field

The present disclosure relates to an augmented reality device comprising a waveguide assembly with a light source attached thereto.

### Description of Related Art

A wearable device such as electronic glasses may include an optical element (e.g., a waveguide assembly) equipped with a waveguide to provide augmented reality. The waveguide may have a structure that confines incident light inside and restricts a path (or region) through which the light may propagate, in order to guide the light to a user's eye. For example, the waveguide may include a diffraction grating that couples the incident light into the waveguide. In addition, the waveguide may propagate the coupled light within the waveguide by total internal reflection.

The above-described information may be provided as a related art for the purpose of helping to understand the present disclosure. No claim or determination is raised as to whether any of the above-described information may be applied as a prior art related to the present disclosure.

### SUMMARY

According to an embodiment, an augmented reality device includes a transparent member in which a waveguide is defined. The transparent member includes a first region through which light is inputted thereto and a second region through which at least a portion of the light is outputted therefrom. The augmented reality device includes a coating layer attached to the transparent member and around the first region of the transparent member in a plan view. The augmented reality device includes a light source, configured to output light onto the first region of the transparent member, and attached to the coating layer. The coating layer is configured to reflect at least a portion of light propagated within the transparent member.

According to an embodiment, an augmented reality (AR) glasses includes a transparent member in which a waveguide is defined. The transparent member includes a first region through which light is inputted thereto and a second region through which at least portion of the light is outputted therefrom. The AR glasses includes a coating layer attached to the transparent member and around the first region of the transparent member in a plan view. The AR glasses includes an adhesive material disposed to overlap at least a portion of the coating layer in the plan view, and a light engine, attached to the coating layer through the adhesive material, and configured to output light onto the first region of the transparent member. The coating layer has a lower refractive index than the transparent member and the adhesive material.

### BRIEF DESCRIPTION OF THE DRAWINGS

FIG. 1 is a block diagram of an electronic device in a network environment according to various embodiments.

FIG. 2 is a perspective view of a wearable device according to an embodiment.

FIG. 3 is a diagram illustrating a lens assembly of a wearable device according to an embodiment.

FIG. 4 is a diagram illustrating an optical path of a waveguide according to an embodiment.

FIG. 5A illustrates a lens assembly to which a light source is attached, according to an embodiment.

FIG. 5B illustrates an optical path of a waveguide according to an embodiment.

FIGS. 6, 7, and 8 illustrate examples of portion(s) of a coating layer of an optical element on which an adhesive material is disposed, according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

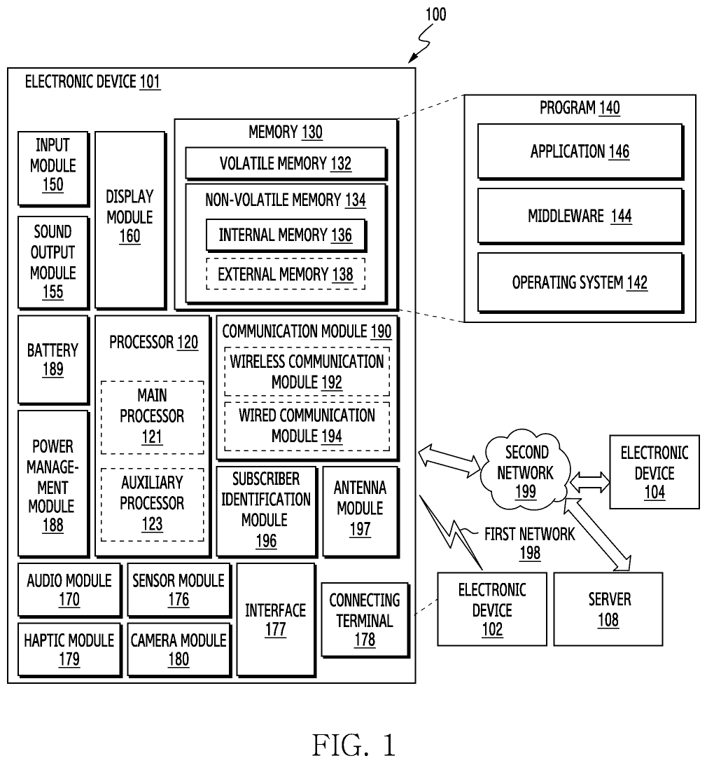

FIG. 1 is a block diagram illustrating an electronic device 101 in a network environment 100 according to various embodiments.

Referring to FIG. 1, in an embodiment, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. In an embodiment, for example, where the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such an embodiment, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, when the electronic device 101 is set to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

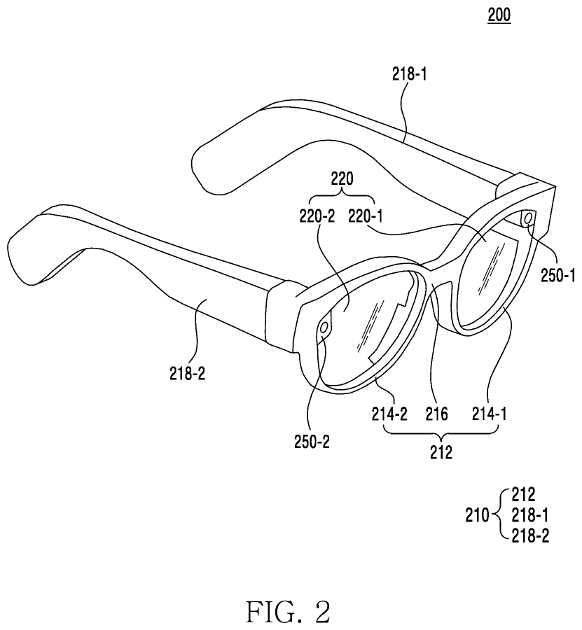

FIG. 2 is a perspective view of a wearable device according to an embodiment.

Referring to FIG. 2, an embodiment of a wearable device 200 (e.g., the electronic device 101 of FIG. 1), which is a head mounted device in a form of glasses, may be smart glasses, electronic glasses, or an augmented reality (AR) device. For example, the wearable device 200 may provide computer generation information superimposed on the real world viewed by a user.

In an embodiment, the wearable device 200 may include a housing 210, lens assemblies 220, a first light source 250-1, and/or a second light source 250-2. For example, the lens assemblies 220 may include a first lens assembly 220-1 and a second lens assembly 220-2.

In an embodiment, a housing 210 may at least partially form an exterior of the wearable device 200. The housing 210 may include a frame 212 accommodating the first lens assembly 220-1 and the second lens assembly 220-2, a first temple 218-1 extending from a side of the frame 212, and a second temple 218-2 extending from another side of the frame 212. The first temple 218-1 may be rotatably coupled, for example, hinge-coupled, to the side of the frame 212, but is not limited thereto. The second temple 218-2 may be rotatably coupled, for example, hinged-coupled, to the other side of the frame 212, but is not limited thereto. The first temple 218-1 and the second temple 218-2 may be supported by the left ear and the right ear of a user wearing the wearable device 200, respectively.

In an embodiment, the frame 212 may include a first rim 214-1 surrounding the first lens assembly 220-1, a second rim 214-2 surrounding the second lens assembly 220-2, and a bridge 216 connecting the first rim 214-1 and the second rim 214-2 to each other.

In an embodiment, the first lens assembly 220-1 may be positioned to correspond to the left eye of the user wearing the wearable device 200. The first lens assembly 220-1 may be formed to be substantially transparent so that the user wearing the wearable device 200 may see an external environment therethrough. The first lens assembly 220-1 may provide a user with visual information based on light provided from the first light source 250-1. In an embodiment, the first lens assembly 220-1 may be supported by coupling a periphery portion of the first lens assembly 220-1 to the first rim 214-1 of the frame 212.

In an embodiment, the second lens assembly 220-2 may be positioned to correspond to the righteye of the user wearing the wearable device 200. The second lens assembly 220-2 may be formed to be substantially transparent so that the user wearing the wearable device 200 may see an external environment therethrough. The second lens assembly 220-2 may provide a user with visual information based on light provided from the second light source 250-2. In an embodiment, the second lens assembly 220-2 may be supported by coupling a periphery portion of the second lens assembly 220-2 to the second rim 214-2 of the frame 212.

In an embodiment, the first light source 250-1 may be configured to output light toward the first lens assembly 220-1. For example, the first light source 250-1 may include a projector, a display, a display engine, an optical engine, or a light engine. For example, the first light source 250-1 may include at least one selected from a liquid crystal display (LCD), a digital mirror display (DMD), a liquid crystal on silicon (LCoS), an organic light emitting diode (OLED), a micro light emitting diode (micro LED), and/or laser beam scanning (LBS).

The first light source 250-1 may be coupled to the housing 210. For example, the first light source 250-1 may be coupled to the frame 212 of the housing 210. For example, the first light source 250-1 may be coupled to the first rim 214-1 of the frame 212. The first light source 250-1 may be positioned on or above a rear surface of the first lens assembly 220-1 by being coupled to the housing 210. The first light source 250-1 may be attached to the rear surface of the first lens assembly 220-1. The rear surface of the first lens assembly 220-1 may be a surface facing the left eye of the user wearing the wearable device 200.

In an embodiment, the first light source 250-1 may be positioned at a periphery portion of the first lens assembly 220-1. Light outputted from the first light source 250-1 may be incident on the first lens assembly 220-1 (e.g., the rear surface of the first lens assembly 220-1). The light outputted from the first light source 250-1 may be provided to the user wearing the wearable device 200 through the first lens assembly 220-1.

In an embodiment, the second light source 250-2 may be configured to output light toward the second lens assembly 220-2. For example, the second light source 250-2 may include a projector, a display, a display engine, an optical engine, or a light engine. For example, the second light source 250-2 may include at least one selected from a liquid crystal display (LCD), a digital mirror display (DMD), a liquid crystal on silicon (LCoS), an organic light emitting diode (OLED), a micro light emitting diode (micro LED), and/or laser beam scanning (LBS).

The second light source 250-2 may be coupled to the housing 210. For example, the second light source 250-2 may be coupled to the frame 212 of the housing 210. For example, the second light source 250-2 may be coupled to the second rim 214-2 of the frame 212. The second light source 250-2 may be positioned on or above a rear surface of the second lens assembly 220-2 by being coupled to the housing 210. The second light source 250-2 may be attached to the rear surface of the second lens assembly 250-2. The rear surface of the second lens assembly 220-2 may be a surface facing the right eye of the user wearing the wearable device 200.

In an embodiment, the second light source 250-2 may be positioned at a periphery portion of the second lens assembly 250-2. Light outputted from the second light source 250-2 may be incident on the second lens assembly 220-2 (e.g., the rear surface of the second lens assembly 220-2). The light outputted from the second light source 250-2 may be provided to the user wearing the wearable device 200 through the second lens assembly 220-2.

Although not illustrated, the wearable device 200 according to an embodiment may include one or more first cameras. The one or more first cameras may be used for head tracking of a degree of freedom (3 DoF), head tracking of 6 DoF, hand detection, hand tracking, and spatial recognition. For example, the one or more first cameras may include one or more global shutter (GS) cameras. The GS camera may have improved performance compared to a rolling shutter (RS) camera in detecting and tracking head, spatial recognition, tracking rapid hand movements, and tracking fine movements such as fingers. The wearable device 200 may perform a simultaneous localization and mapping (SLAM) function through spatial recognition for 6 DoF and depth photographing by using the one or more first cameras. In addition, the wearable device 200 may perform a user gesture recognition function using the one or more first cameras. For example, the one or more first cameras may include a first recognition camera positioned on the first rim 214-1 of frame 212 and a second recognition camera positioned on the second rim 214-2 of frame 212.

Although not illustrated, the wearable device 200 may include one or more second cameras. The one or more second cameras may be used to detect and track a user's pupil (or gaze). The one or more second cameras may be used for positioning a center of a virtual image projected onto the lens assemblies 220 according to a direction in which a pupil of a user wearing the wearable device 200 gazes. For example, the one or more second cameras may include a GS camera to detect a pupil and to track a fast pupil movement. For example, the one or more second cameras may include a first eye tracking (ET) camera corresponding to the user's left eye and a second ET camera corresponding to the user's right eye. For example, the first ET camera may be positioned between the first rim 2141) and the bridge 216 of the frame 212, and the second ET camera may be positioned between the second rim 214-2 and the bridge 216 of the frame 212. The first ET camera and the second ET camera may have a same performance and standard as each other. In addition, the wearable device 200 may include a first LED disposed in the frame 212 to be adjacent to the first ET camera to facilitate gaze detection of the first ET camera and/or a second LED disposed in the frame 212 to be adjacent to the second ET camera to facilitate gaze detection of the second ET camera.

Although not illustrated, the wearable device 200 may include a third camera. For example, the third camera may be referred to as a high resolution (HR), an HR camera, a photo video (PV), or a PV camera. The third camera may include a high-resolution camera. The third camera may include a color camera equipped with functions for obtaining a high-quality image, such as an auto-focus (AF) function and an optical image stabilization (OIS). For example, the third camera may include a GS camera or an RS camera. For example, the third camera may be positioned on the bridge 216 of the frame 212. In addition, the wearable device 200 may include a third LED positioned adjacent to the third camera. The third LED may be used as a means of supplementing ambient brightness when photographing with the third camera.

Although not illustrated, the wearable device 200 may include a first printed circuit board disposed in the first temple 218-1 and/or a second printed circuit board disposed in the second temple 218-2. Various components (e.g., at least one of the components of FIG. 1) of the wearable device 200 may be disposed on the first printed circuit board and/or the second printed circuit board. In addition, the wearable device 200 may include one or more flexible printed circuit boards electrically connecting various electronic components (e.g., one or more first cameras) of the wearable device 200 to the first printed circuit board and/or the second printed circuit board.

An optical system of the wearable device 200 will be described in detail with reference to the following drawings. In the drawings, the same reference numerals may be assigned to the same components, and any repetitive detailed descriptions of the same or like configurations may not be repeated. In the following descriptions referring to a particular drawing, reference numerals of other drawings may be referenced.

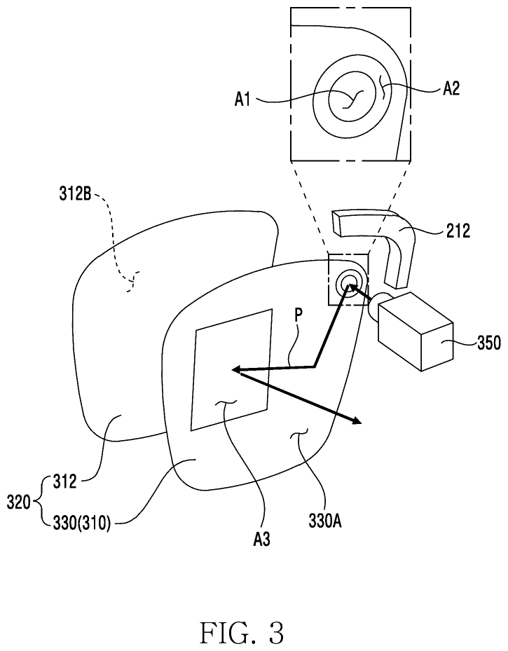

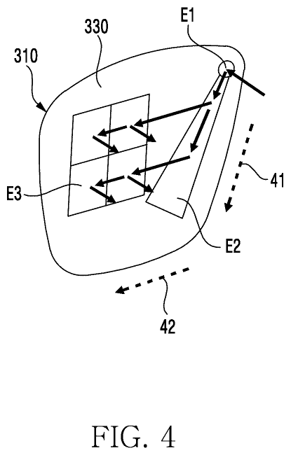

FIG. 3 is a diagram illustrating a lens assembly of a wearable device according to an embodiment. FIG. 4 is a diagram illustrating an optical path of a waveguide according to an embodiment. In FIG. 3, for convenience of description, the frame 212 and a light source 350 are illustrated together.

Referring to FIG. 3, according to an embodiment, a lens assembly 320 may include a front cover 312 and an optical element 310 facing the front cover 312. The lens assembly 320 may be an example of the first lens assembly 320-1 or the second lens assembly 320-2 of FIG. 2. The optical element 310 may be referred to as a waveguide assembly.

In an embodiment, a front cover (or lens) 312 may be formed to be substantially transparent. A surface 312B of the front cover 312 may form or define a front surface of the lens assembly 320. For example, the surface 312B of the front cover 312 may be a surface (i.e., a front surface) opposite to a rear surface of the front cover 312 facing the optical element 310. The front surface of the lens assembly 320 may be a surface opposite to a body of a user wearing the wearable device 200 (i.e., a surface facing an external environment while the electronic device 200 is worn by the user). A periphery portion of the front cover 312 may be coupled to (e.g., inserted into) a portion of the frame 212 (e.g., the first rim 214-1 or the second rim 214-2).

In an embodiment, the optical element 310 may receive light from the light source 350. The optical element 310 may be configured to project at least a portion of the received light toward an eye of the user wearing the wearable device 200. For example, the optical element 310 may be configured to project at least a portion of the received light toward the eye of the user through a waveguide providing an optical path (P) to be described later. A periphery portion of the optical element 310 (or a transparent member 330) may be coupled to another portion of the frame 212 (e.g., the first rim 214-1 or the second rim 214-2).

In an embodiment, the optical element 310 may include the transparent member 330. The transparent member 330 may include, be formed from or based on at least one of glass, plastic, or polymer. The transparent member 330 may be formed to be substantially transparent or translucent. The transparent member 330 may be referred to as a substrate.

The transparent member 330 may include a waveguide for controlling a characteristic of inputted light. The waveguide of the transparent member 330 may include optical elements such as a diffractive element or a holographic element. The waveguide may include or be made of glass, plastic, polymer, photopolymer, nano particles, spacer, or a mixture including at least two or more thereof. The waveguide may include a nanopattern formed or defined on a portion of an inner or outer surface thereof, for example, a grating structure having a polygonal or curved shape. According to an embodiment, light incident on an end of the waveguide may be propagated inside the waveguide and provided to the user. In addition, the waveguide formed as a free-form prism may provide the incident light to the user through a reflective mirror. The waveguide may include at least one of at least one diffractive element (e.g., a diffractive optical element (DOE), a holographic optical element (HOE)) or a reflective element (e.g., a reflective mirror). The waveguide may guide light emitted from the light source 350 to the user's eye, by using the at least one diffractive element or the reflective element included in the waveguide.

In an embodiment, the diffractive element of the waveguide may include an input optical member (e.g., the input coupler E1 of FIG. 4) and an output optical member (e.g., the output coupler E3 of FIG. 4). For example, the input optical member may mean an input grating area, and the output optical member may mean an output grating area. The input optical member may serve as an input terminal that diffracts (or reflects) light outputted from the light source 350 to transmit it to the output optical member of the transparent member 330. The output optical member may serve as an outlet that diffracts (or reflects) light transmitted from the input optical member of the transparent member 330 to the user's eye.

In an embodiment, a reflective element of the waveguide may include a total internal reflection (TIR) optical element or a TIR waveguide for TIR. For example, the TIR, which is a method of guiding light, may refer to forming an incident angle such that light (e.g., a virtual image) inputted through an input grating area is 100% reflected on a surface (e.g., a specific surface) of the waveguide and is 100% delivered to an output grating area.

In an embodiment, light emitted from the light source 350 may have an optical path guided to the waveguide through an input optical member. Light moving inside the waveguide may be guided toward the user's eye through an output optical member.

The waveguide has been described as being included in the transparent member 330, but the transparent member 330 may be the waveguide.

In an embodiment, the transparent member 330 may include a first surface 330A. The first surface 330A of the transparent member 330 may face a user wearing the wearable device 200. For example, the first surface 330A of the transparent member 330 may at least partially form a rear surface of the lens assembly 320, which is opposite to the front surface of the lens assembly 320.

In an embodiment, as shown in FIG. 3, the transparent member 330 may include a first region A1, a second region A2, and/or a third region A3. The first region A1 may be a region in which light emitted from the light source 350 is received. That is, the first region A1 may be a region to which light emitted from the light source 350 is incident. The second region A2 may extend from the first region A1. The second region A2 may surround the first region A1. For example, the second region A2 may surround a periphery of the first region A1. As a non-limiting example, the periphery of the first region A1 may be fully surrounded by the second region A2. The third region A3 may be a region in which light inputted to the optical element 310 is outputted. As a non-limiting example, the first region A1, the second region A2, and the third region A3 may be included in or defined on the first side 330A of the transparent member 330.

In an embodiment, the transparent member 330 may form an optical path (or light path) P. For example, the optical path P may be formed at least partially by the waveguide of the transparent member 330. For example, the optical path P of the transparent member 330 may extend from the first region A1 of the transparent member 330 to the third region A3. For example, light incident through the first region A1 of the transparent member 330 may be propagated inside the transparent member 330 along the optical path P and then output through the third region A3.

For example, referring to FIG. 4 together with FIG. 3, the transparent member 330 may include an in-coupler E1, an expander E2, and an out-coupler E3 which at least partially form the optical path P of the optical element 310. The in-coupler E1, the expander E2, and the out-coupler E3 may be included or defined in the waveguide of the transparent member 330.

In an embodiment, the in-coupler E1 may be embedded in the transparent member 330 to correspond (e.g., overlap) to the first region A1 of the transparent member 330. The expander E2 may be positioned between the in-coupler E1 and the out-coupler E3 on the optical path P. The in-coupler E1, the expander E2, and the out-coupler E3 may respectively include a diffraction grating or a holographic optical element.

In an embodiment, the in-coupler E1 may couple light incident thereto through the first region A1 into the transparent member 330, and re-direct it in a direction of the expander E2. The light coupled in the transparent member 330 may move to the expander E2 through total internal reflection (TIR) inside the transparent member 330. The expander E2 may replicate (or pupil expansion) the coupled light in the transparent member 330 along a first axis 41, and provide it to the out-coupler E3. The light replicated and re-directed by the expander E2 may move to the out-coupler E3 through TIR inside the transparent member 330. The out-coupler E3 may be configured to replicate (or pupil expansion) light along a second axis 42 different from the first axis 41, and out-couple light from the optical element 310. By the out-coupler E3, out-coupled light may be projected into the user's eye.

The in-coupler E1 may be referred to as an input coupler, an in-coupling, an in-coupling element, or an input grating. The expander E2 may be referred to as an intermediate, an expansion, or a fold. The out-coupler E3 may be referred to as an output coupler, out-coupling, out-coupling element, or an output grating.

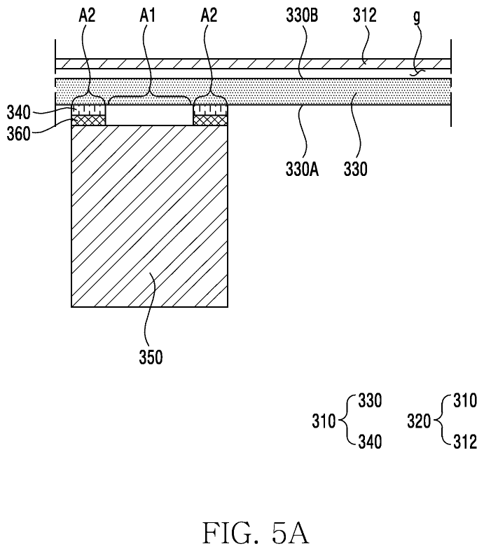

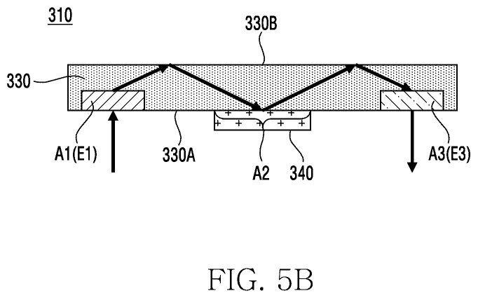

FIG. 5A illustrates a lens assembly to which a light source is attached, according to an embodiment. FIG. 5B illustrates an optical path of a waveguide, according to an embodiment.

Referring to FIG. 5A, in an embodiment, the optical element 310 may include a coating layer 340. For example, the coating layer 340 may be formed on a second region A2 of the transparent member 330, or attached (or bonded) to the transparent member 330 to define the second region A2. The coating layer 340 may include a low refractive coating layer or a reflective coating layer (e.g., mirror coating).

In an embodiment, the transparent member 330 of the optical element 310 may be spaced apart from the front cover 312 through a gap g. For example, a second surface 330B of the transparent member 330 opposite to the first surface 330A may be spaced apart from the front cover 312 through the gap g. A material (e.g., air) having a lower refractive index than the transparent member 330 may be filled in the gap g. Accordingly, it is possible to reduce deterioration of total reflection performance for transmitting light inside the transparent member 330 through the second surface 330B, which is the interface between the transparent member 330 and the gap g. Accordingly, light inside the transparent member 330 may be effectively totally reflected by the second surface 330B, which is an interface between the transparent member 330 and the gap g, thereby reducing deterioration of total internal reflection (TIR) performance.

In an embodiment, the light source 350 may be attached to the coating layer 340 of the optical element 310. The coating layer 340 and the light source 350 of the optical element 310 may be attached to each other through an adhesive material 360 interposed between the coating layer 340 and the light source 350. As a non-limiting example, the adhesive material 360 may include or be formed of a polymer material. As a non-limiting example, the adhesive material 360 may include an adhesive such as bond, tape, or glue. The light source 350 attached to the coating layer 340 of the optical element 310 may be configured to output light to the first region A1 of the transparent member 330.

In an embodiment, the coating layer 340 attached to the transparent member 330 including the waveguide may be configured to reflect at least a portion of light propagated inside the waveguide of the transparent member 330. For example, referring to FIG. 5B, light coupled inside the transparent member 330 through the first region A1 (or the in-coupler E1) may be totally reflected at the interface between the second region A2 of the transparent member 330 and the coating layer 340. Accordingly, even when the light source 350 is attached to the optical element 310, deterioration of total internal reflection performance may be reduced or may not occur. In a comparative example, where the light source 350 is directly attached to the transparent member 330 without the coating layer 340, light inside the transparent member 330 may penetrate to the outside through the adhesive material 360. For another comparative example, for the attachment of the light source 350, it may be attached to another member that is distinct from the optical element 310, for example, a rear cover positioned opposite to the front cover 312 to be spaced apart from the optical element 310. In this case, a thickness, a weight, and a manufacturing cost of the lens assembly 320 may be increased due to the rear cover.

In an embodiment, a refractive index of the coating layer 340 may be less than a refractive index of the transparent member 330. For example, the refractive index of the coating layer 340 may be less than a refractive index of the adhesive material 360. For example, the refractive index of the coating layer 340 may be less than a refractive index of an optical adhesive. For a non-limiting example, the refractive index of the coating layer 340 may be less than about 1.4.

In an embodiment, the transparent member 330 may be used for red (hereinafter, R), green (hereinafter, G), and blue (hereinafter, B), but is not limited thereto. For example, the transparent member 330 (e.g., the first transparent member) may be used for any one of R, G, and B. In this case, the optical element 310 may further include a second transparent member in which a waveguide for another one of R, G, and B is formed, and a third transparent member in which a waveguide for a remaining one of R, G, and B is formed. For example, the transparent member 330 may be used for R and G, and in this case, the optical element 310 may further include another transparent member in which a waveguide for G and B is formed.

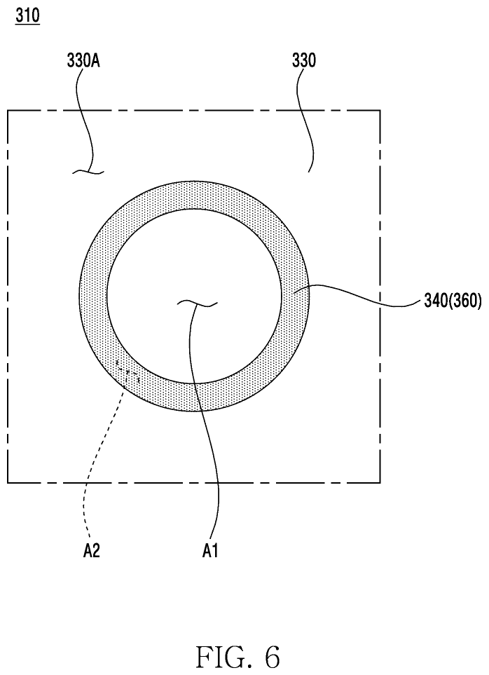

FIGS. 6, 7, and 8 illustrate examples of portion(s) of a coating layer of an optical element on which an adhesive material is disposed, according to an embodiment.

According to an embodiment, the adhesive material 360 may be disposed on at least a portion of the coating layer 340 to attach the light source 350 in a plan view (or when viewed in a thickness direction of the transparent member 330).

For example, referring to FIG. 6, according to an embodiment, an adhesive material 360 may be disposed on (or to overlap) the entire coating layer 340 in a plan view.

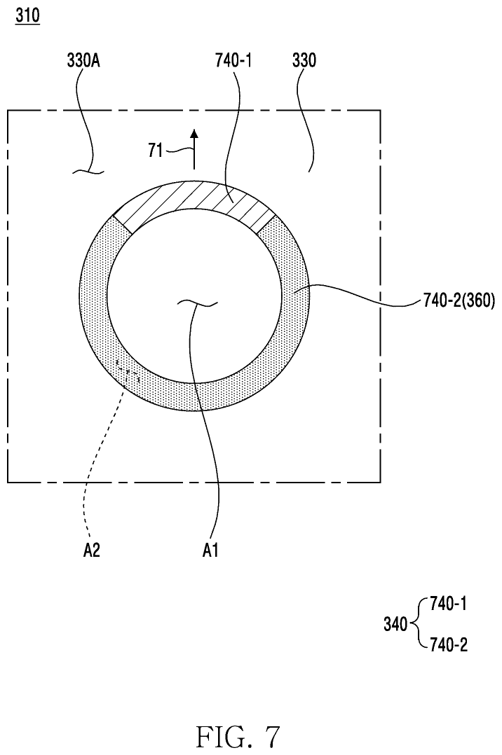

For example, referring to FIG. 7, according to an embodiment, the adhesive material 360 may be disposed on (or to overlap) a portion of the coating layer 340. For example, the coating layer 340 may include a first portion 740-1 extending along a portion of a periphery of the first region A1 and a second portion 740-2 extending along a remaining portion of the periphery of the first region A1. For example, the first portion 740-1 of the coating layer 340 may be formed on the second region A2 to surround a portion of the first region A1, and the second portion 740-2 of the coating layer 340 may extend from a first end of the first portion 740-1 to a second end of the first portion 740-1 to surround a remaining portion of the first region A1.

In an embodiment, the adhesive material 360 may be disposed on the second portion 740-2 among the first portion 740-1 and the second portion 740-2 of the coating layer 340. For example, the adhesive material 360 may not be disposed on (or disposed not to overlap) the first portion 740-1 of the coating layer 340. In this case, the light source 350 attached to the second portion 740-2 of the coating layer 340 by the adhesive material 360 may be spaced apart from the first portion 740-1 of the coating layer 340 through an air gap.

In an embodiment, the first portion 740-1 of the coating layer 340 may face a first direction 71. That is, an imaginary line extending from a center of the first region A1 to a center of the first portion 740-1 of the coating layer 340 is in the first direction 71. For example, the first direction 71 may be a direction of the expander E2. For example, the first direction 71 may be parallel to a direction (e.g., the first axis 41) of an axis of pupil expansion provided by the expander E2, but is not limited thereto. For example, the first portion 740-1 of the coating layer 340 may overlap the optical path P of the optical element 310 in a plan view. As a non-limiting example, the first portion 740-1 of the coating layer 340 may partially overlap the expander E2 in a plan view.

In another embodiment, the coating layer 340 may include the second portion 740-2 and may not include the first portion 740-1. In this case, a portion of the second region A2 of the transparent member 330 corresponding to the first portion 740-1 of the coating layer 340 may be spaced apart from the light source 350 through the air gap.

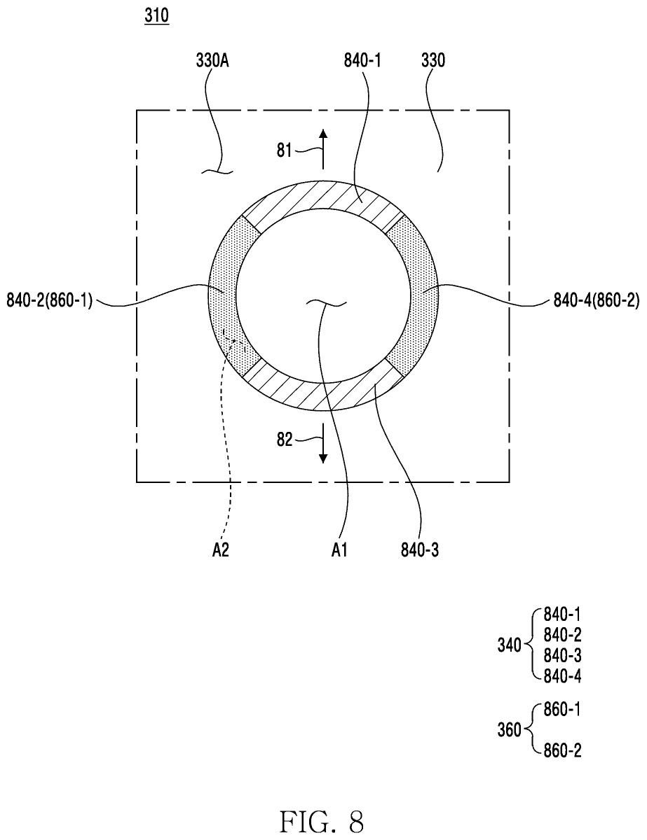

For example, referring to FIG. 8, according to an embodiment, the adhesive material 360 may be disposed on portions of the coating layer 340 spaced apart from each other. For example, the coating layer 340 may include a first portion 840-1 (e.g., the first portion 740-1 of FIG. 7), a second portion 840-2, a third portion 840-3, and a fourth portion 840-4. The first portion 840-1, the second portion 840-2, the third portion 840-3, and the fourth portion 840-4 of the coating layer 340 may be sequentially disposed along the periphery of the first region A1 of the transparent member 330. For example, the first portion 840-1 of the coating layer 340 may extend from the fourth portion 840-4 to the second portion 840-2, the second portion 840-2 may extend from the first portion 840-1 to the third portion 840-3, the third portion 840-3 may extend from the second portion 840-2 to the fourth portion 840-4, and the fourth portion 840-4 may extend from the third portion 840-3 to the first portion 840-1.

In an embodiment, the adhesive material 360 may be disposed on the second portion 840-2 and the fourth portion 840-4 among the portions 840-1, 840-2, 840-3, and 840-4 of the coating layer 340. For example, the adhesive material 360 may not be disposed on (or to overlap) the first portion 840-1 and the third portion 840-3 of the coating layer 340. In this case, the light source 350 attached to the second portion 840-2 and the fourth portion 840-4 of the coating layer 340 by the adhesive material 360 may be spaced apart from the first portion 840-1 and the third portion 840-3 of the coating layer 340 through an air gap.

In an embodiment, the first portion 840-1 of the coating layer 340 may face in a first direction 81 (e.g., the first direction 71). That is, an imaginary line extending from a center of the first region A1 to a center of the first portion 740-1 of the coating layer 340 is in the first direction 81. In an embodiment, the third portion 840-3 of the coating layer 340 may face a second direction 82. That is, an imaginary line extending from a center of the first region A1 to a center of the third portion 840-3 of the coating layer 340 is in the second direction 82. As a non-limiting example, the second direction 82 may be opposite to the first direction 81. For example, the second direction 82 may be a direction toward a portion of the frame 212 closest to the first region A1 of the transparent member 330. For example, the third portion 840-3 of the coating layer 340 may be closer to the portion of the frame 212 than the first portion 840-1.

In another embodiment, the coating layer 340 may include the second portion 840-2 and the fourth portion 840-4, and may not include the first portion 840-1 and/or the third portion 840-3. In such an embodiment, the first portion and/or the second portion of the second region A2 of the transparent member 330 corresponding to the first portion 840-1 and/or the third portion 840-3 of the coating layer 340 may be spaced apart from the light source 350 through an air gap.

The invention should not be construed as being limited to the embodiments set forth herein. Rather, these embodiments are provided so that this disclosure will be thorough and complete and will fully convey the concept of the invention to those skilled in the art.

According to an embodiment, an augmented reality device 200 may include a transparent member 330 in which a waveguide is defined. The transparent member 330 may include a first region A1 through which light is inputted to the transparent member 330 and a second region A3 through which at least a portion of the light is outputted from the transparent member 330. The augmented reality device 200 may include a coating layer 340 attached directly to the transparent member 330 and around the first region A1 of the transparent member 330 in a plan view (or when viewed in a thickness direction of the transparent member 330). The augmented reality device 200 may include a light source 350, configured to output light to the first region A1 of the transparent member 330, and attached to the coating layer 340. The coating layer 340 may be configured to (totally) reflect at least a portion of light propagated within the transparent member 330.

In an embodiment, a refractive index of the coating layer 340 may be less than a refractive index of the transparent member 330.

In an embodiment, the augmented reality device 200 may further include an adhesive material 360 interposed between the light source 350 and the coating layer 340.

In an embodiment, a refractive index of the coated layer 340 may be less than a refractive index of the adhesive material 360.

In an embodiment, a refractive index of the coating layer 340 may be less than about 1.4.

In an embodiment, the coating layer 340 may include a mirror coating.

In an embodiment, an entire portion of the adhesive material 360 may be disposed to overlap a portion of the coating layer 340 in the plan view.

In an embodiment, the coating layer 340 may include a first portion 740-1 or 840-1 and a second portion 740-2 or 840-2. The first portion 740-1 or 840-1 of the coating layer 340 may face the light source 350 and not overlap the adhesive material 360 in the plan view. The adhesive material 360 may be disposed to overlap the second portion 740-2 or 840-2 of the coating layer 340 in the plan view.

In an embodiment, a waveguide of the transparent member 330 may include an optical path P extending from the first region A1 of the transparent member 330 to the second region A3 of the transparent member 330. The first portion 740-1 or 840-1 of the coating layer 340 may overlap the optical path P in the plan view.

In an embodiment, the transparent member 330 may include a surface 330A facing an eye of a user wearing the augmented reality device 200. The surface 330A of the transparent member 330 may include the first region A1 and the second region A3.

In an embodiment, the waveguide of the transparent member 330 may include an input coupler E1, an expander E2, and an output coupler E3 at least partially forming the optical path P. The input coupler E1 may be configured to couple light received through the first region A1 of the transparent member 330 into the transparent member 330. The expander E2 may be configured to transmit the light coupled by the input coupler E1 to the output coupler E3 to provide a pupil expansion along the first direction 41. The output coupler E3 may be configured to project light transmitted by the expander E2 toward the eye of the user in a way such that pupil expansion is provided in a second direction 42 different from the first direction 41. The first portion 740-1 or 840-1 and the second portion 740-2 or 840-2 of the coating layer 340 may be positioned in a way such that the first portion 740-1 or 840-1 among the first portion 740-1 or 840-2 and the second portion 740-2 or 840-2 faces the expander E2.

In an embodiment, in the plan view, the first portion 740-1 or 840-1 of the coating layer 340 may at least partially overlap the expander E2.

In an embodiment, the second portion 740-2 or 840-2 of the coating layer 340 may extend from the first portion 740-1 or 840-1 of the coating layer 340. The coating layer 340 may further include a third portion 840-3 extending from the second portion 740-2 or 840-2 of the coating layer 340, and opposite to the first portion 740-1 or 840-1 of the coating layer 340, and a fourth portion 840-4 extending from the third portion 840-3 of the coating layer 340 to the first portion 740-1 or 840-1 of the coating layer 340, and opposite to the second portion 740-2 or 840-2 of the coating layer 340. The adhesive material 360 may be disposed to overlap the fourth portion 840-4 of the coating layer 340 in the plan view. The third portion 840-3 of the coating layer 340 may face the light source 350 and not overlap the adhesive material 360 in the plan view.

In an embodiment, the augmented reality device 200 may include a frame 212 accommodating the transparent member 330. The second portion 740-2 or 840-2 of the coating layer 340 may be closer to the frame 212 than the first portion 740-1 or 840-1 of the coating layer 340.

In an embodiment, the augmented reality device 200 may include a front cover 312 accommodated in the frame 212 to face the transparent member 330. The front cover may be spaced apart from the transparent member 330 through an air gap g.

According to an embodiment, the augmented reality (AR) glasses 200 may include a transparent member 330 in which a waveguide is defined. The transparent member 330 may include a first region A1 through which light is inputted to the transparent member 330 and a second region A3 through which at least a portion of the light is outputted from the transparent member 330. The AR glasses 200 may include a coating layer 340 attached directly to the transparent member 330 and around the first region A1 of the transparent member 330 in a plan view (or when viewed in a thickness direction of the transparent member 330). The AR glasses 200 may include an adhesive material 360 disposed to overlap at least a portion of the coating layer 340 in the plan view, and a light engine 350, attached to the coating layer 340 through the adhesive material 360, and configured to output light onto the first region A1 of the transparent member 330. The coating layer 340 may have a refractive index less than the transparent member 330 and the adhesive material 360.

In an embodiment, the refractive index of the coating layer 340 may be less than about 1.4.

In an embodiment, the coating layer 340 may include a mirror coating.

In an embodiment, the coating layer 340 may include a first portion 740-1 or 840-1 and a second portion 740-2 or 840-2. The first portion 740-1 or 840-1 of the coating layer 340 may be spaced apart from the optical engine 350 through an air gap. The adhesive material 360 may be disposed to overlap the second portion 740-2 or 840-2 of the coating layer 340.

In an embodiment, the AR glasses 200 may include a frame 212 accommodating the transparent member 330. The second portion 740-2 or 840-2 of the coating layer 340 may be closer to the frame 212 than the first portion 740-1 or 840-1 of the coating layer 340.

The effects that can be obtained from the present disclosure are not limited to those described above, and any other effects not mentioned herein will be clearly understood by those having ordinary knowledge in the art to which the present disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one selected from A and B,” “at least one of A or B,” “A, B, or C,” “at least one of A, B, and C,” “at least one selected from A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An augmented reality device comprising:
a transparent member in which a waveguide is defined, wherein the transparent member includes a first region through which light is inputted thereto and a second region through which at least a portion of the light is outputted therefrom;
a coating layer attached to the transparent member and around the first region of the transparent member in a plan view; and
a light source, configured to output light onto the first region of the transparent member, and attached to the coating layer,
wherein the coating layer is configured to reflect at least a portion of light propagated within the transparent member.

2. The augmented reality device of claim 1,
wherein a refractive index of the coating layer is less than a refractive index of the transparent member.

3. The augmented reality device of claim 1, comprising an adhesive material interposed between the light source and the coating layer.

4. The augmented reality device of claim 3,
wherein a refractive index of the coating layer is less than a refractive index of the adhesive material.

5. The augmented reality device of claim 1,
wherein a refractive index of the coating layer is less than about 1.4.

6. The augmented reality device of claim 1,
wherein the coating layer includes a mirror coating.

7. The augmented reality device of claim 3,
wherein the adhesive material is disposed to overlap a portion of the coating layer in the plan view.

8. The augmented reality device of claim 7, wherein:
the coating layer includes a first portion and a second portion;
the first portion of the coating layer faces the light source and does not overlap the adhesive material in the plan view; and
the adhesive material is disposed to overlap the second portion of the coating layer in the plan view.

9. The augmented reality device of claim 8, wherein:
the waveguide of the transparent member includes an optical path extending from the first region of the transparent member to the second region of the transparent member; and
the first portion of the coating layer overlaps the optical path in the plan view.

10. The augmented reality device of claim 9, wherein:
the transparent member includes a surface facing an eye of a user wearing the augmented reality device; and
the surface of the transparent member includes the first region and the second region.

11. The augmented reality device of claim 9, wherein:
the waveguide of the transparent member includes an input coupler, an expander, and an output coupler, which at least partially form the optical path;
the input coupler is configured to couple light received through the first region of the transparent member into the transparent member;
the expander is configured to transmit light coupled by the input coupler to the output coupler to provide pupil expansion along a first direction;
the output coupler is configured to project light transmitted by the expander toward an eye of a user wearing the augmented reality device to provide pupil expansion in a second direction different from the first direction; and
the first portion and the second portion of the coating layer are positioned in a way such that the first portion from among the first portion and the second portion of the coating layer faces the expander.

12. The augmented reality device of claim 11,
wherein the first portion of the coating layer at least partially overlaps the expander in the plan view.

13. The augmented reality device of claim 11, wherein:
the second portion of the coating layer extends from the first portion of the coating layer;
the coating layer further includes:
a third portion, extending from the second portion of the coating layer, and opposite to the first portion of the coating layer; and
a fourth portion, extending from the third portion of the coating layer to the first portion of the coating layer, and opposite to the second portion of the coating layer, wherein the adhesive material is disposed to overlap the fourth portion in the plan view; and
the third portion of the coating layer faces the light source and does not overlap the adhesive material in the plan view.

14. The augmented reality device of claim 13, comprising a frame which accommodates the transparent member, and
wherein the second portion of the coating layer is closer to the frame than the first portion of the coating layer.

15. The augmented reality device of claim 14, comprising a front cover accommodated in the frame to face the transparent member, and
wherein the front cover is spaced apart from the transparent member through an air gap.

16. An augmented reality (AR) glasses comprising:
a transparent member in which a waveguide is defined, wherein the transparent member includes a first region through which light is inputted thereto and a second region through which at least portion of the light is outputted therefrom;
a coating layer attached to the transparent member and around the first region of the transparent member in a plan view;
an adhesive material disposed to overlap at least a portion of the coating layer in the plan view; and
a light engine, attached to the coating layer through the adhesive material, and configured to output light onto the first region of the transparent member, and
wherein the coating layer has a lower refractive index than the transparent member and the adhesive material.

17. The AR glasses of claim 16,
wherein a refractive index of the coating layer is less than about 1.4.

18. The AR glasses of claim 16,
wherein the coating layer includes a mirror coating.

19. The AR glasses of claim 16, wherein:
the coating layer includes a first portion and a second portion;
the first portion of the coating layer is spaced apart from the light engine through an air gap; and
the adhesive material is disposed to overlap the second portion of the coating layer in the plan view.

20. The AR glasses of claim 19,
comprising a frame which accommodates the transparent member, and
wherein the second portion of the coating layer is closer to the frame than the first portion of the coating layer.
